(19) United States
(12) Patent Application Publication
(10) Pub. No.: US 2003/0206239 A1
(43) Pub. Date: Nov. 6, 2003

(54) Menu navigation system and method

(76) Inventor: Amy E. Battles, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/139,447

(22) Filed: May 6, 2002

(51) Int. Cl. H04N 5/222

(52) U.S. Cl. 348/333.02

(57) ABSTRACT

One embodiment provides for navigating digital camera menus by receiving a first signal from a first controller, the first controller associated with a plurality of first soft keys, each one of the first soft keys on a corresponding one of a plurality of menus and having different text, such that when the first signal is received a first operation is performed, the first operation being substantially the same for each one of the plurality of first soft keys; and by receiving a second signal from a second controller, the second controller associated with a plurality of second soft keys, each one of the second soft keys on a corresponding one of the plurality of menus and having different text, such that when the second signal is received a second operation is performed, the second operation being substantially the same for each one of the plurality of second soft keys.

### TECHNICAL FIELD

The present invention is generally related to digital camera technology and, more particularly, is related to a system and method for navigating a digital camera menu.

### BACKGROUND OF THE INVENTION

In digitally based image capturing devices an image or “photograph” of an object is stored in a digital data format in the memory within, or coupled to, the image capturing device. A nonlimiting example of a digital image capturing device is the digital camera that captures still images and/or video images. Digital cameras sometimes include a display that, in selected operating modes, shows a menu having soft button identifiers. The menu shows operating options that are selectable by the user. Digital cameras typically have a plurality of controllers, such as buttons, associated with the display. A soft button identifier is typically displayed on the menu, just above the corresponding button, indicating variable descriptive text such that a user understands what operating options are controlled by the button.

FIG. 1A is a simplified exemplary prior art digital camera 100 having menu 104 displayed on display 102. Menu 104 shows three generic selections that may be selected by a user. The status of options are indicated by the presence of a status icon, such as checkmark 106. Thus, the presence of checkmark 106 indicates that Option 2 is activated, and the absence of a similar checkmark indicates that Option 1 is not activated.

When the digital camera 100 is operating to display the exemplary menu 104, the user selects an option by actuating a controller, such as the four-way controller 108. The user, by actuating the four-way controller 108, highlights an option as indicated by highlight bar 110. For example, the menu 104 is illustrated as having Option 3 selected as indicated by highlight bar 110. Accordingly, the user understands that Option 3 may be changed from an unselected status to a selected status (since no checkmark is currently displayed for Option 3).

On the exemplary menu 104, an interface is employed to instruct the user as to the functionality of various controllers. Thus, the soft button instruction 112, referred to herein as a soft key for convenience, displays the text “SELECT” to indicate that if the user actuates controller 114, residing just below the soft key 112, that Option 3 will be selected (thereby selecting Option 3 and changing the menu 104 to display a checkmark adjacent to Option 3) and the menu 104 will be exited. That is, actuation of controller 114 communicates a signal indicating that the operation associated with soft key 112 is to be performed.

The user may select/deselect other options in a similar manner. When the user has completed configuration of digital camera 100 with the selectable options as provided by menu 104, the user exits menu 104 and the display 102 returns to a predefined operating mode. However, in the event of an error, the user may desire to exit from menu 104 without saving any changes.

Here, the soft key 116 displaying the text “EXIT” indicates to the user that actuation of controller 118 cancels option setting changes and exits from menu 104.

Typically, many different types of menus are displayed on display 102. Four-way controller 108, controller 114 and controller 118 allow navigation in the various menus and selection of desired options. FIG. 1B is another simplified exemplary prior art menu showing three generic settings that may be selected by a user. Menu 120 enables the user to change settings of the digital camera 100. Setting 1 has a setting of 1234, Setting 2 has a setting of ABCD, and Setting 3 has a setting of 10. For illustrative purposes, assume that the user desires to reduce the value of Setting 3. Using four-way controller 108, Setting 3 is highlighted, as indicated by highlight bar 110.

Once highlighted, diamonds 122 and 124 indicate to the user how to alter the value of Setting 3 using four-way controller 108. Since the left-pointing diamond 122 corresponds to the left-pointing arrow 126 on four-way controller 108, the user understands that actuating the left side of four-way controller 108 will reduce the value of Setting 3. Similarly, the right-pointing diamond 124 corresponds to the right-pointing arrow 128 on four-way controller 108 such that the user understands that actuating the right side of four-way controller 108 will increase the value of Setting 3.

On menu 120, soft key 112 is labeled as “DEFAULT” to indicate that actuation of controller 114 will cause the current highlighted setting to return to a default value. For example, if the default value of Setting 3 is 20, actuation of 114 will cause the value of Setting 3 to change from 10 to 20.

Furthermore, on menu 120, soft key 116 is labeled as “EXIT” to indicate that actuation of controller 118 will cause an exiting from menu 120 and a saving of any revised setting value(s). Thus, after the user makes desirable setting changes, actuation of the “EXIT” soft key 116 provides a convenient and reliable way to save the current setting values and to exit from menu 120.

Table 1 summarizes the functionality of the soft keys 112 and 116 for the simplified illustrative example menus 104 and 120 describe above.

TABLE 1
Exemplary Soft Key Operations

| | | |
|---|---|---|
| Menu | Soft Key Text | Result of Actuating Corresponding Controller |

| | | |
|---|---|---|
| 104 | SELECT | Change status of current highlighted option and |
| | | exit from menu |
| 104 | EXIT | Cancel any option changes and exit from menu |
| 120 | DEFAULT | Cancel any setting changes and use default value |
| 120 | EXIT | Save any setting changes and exit from menu |

Table 1 and the above-described operation of menus 104 and 120 illustrate in an exemplary manner a prior art deficiency in that the functionality of the soft keys 112 changes for each menu. The variety of soft keys functions increases with the number of menus provided for the operation of digital camera 100. Furthermore, some cameras employ a third controller, and a corresponding soft key, located between controllers 114 and 116. Thus, a greater number of soft key functions, which may have even greater complexity than the simplified illustrative examples above, may be encountered during menu operation.

Accordingly, the operation of an operating system having a plurality of menus becomes very complex. Such complexity is desirable in cameras designed for advanced users. However, for a digital camera 100 designed for simplified operation by users unfamiliar with menu operation and/or cameras, such complex menu systems may be difficult to understand and result in frustration and dissatisfaction with the camera 100. Furthermore, such complex menu control systems require complex programming.

For convenience, the above-described operation of menus 104 and 120 were described as operating digital camera 100. Such complex menu operating systems are encountered in other devices. For example, electronic film-based cameras employ menu systems. Menu systems are encountered on other devices, such a facsimile machines, copy machines, kiosk devices, personal computers (desktops, lap tops, notebooks, etc.), pagers, personal digital assistants (PDAs) and other devices.

### SUMMARY OF THE INVENTION

The present invention provides a system and method for navigating a digital camera menu. Briefly described, in architecture, one embodiment comprises the steps of receiving a first signal from a first controller, the first controller associated with a plurality of first soft keys, each one of the first soft keys on a corresponding one of a plurality of menus and having different text, such that when the first signal is received a first operation is performed, the first operation being substantially the same for each one of the plurality of first soft keys; and receiving a second signal from a second controller, the second controller associated with a plurality of second soft keys, each one of the second soft keys on a corresponding one of the plurality of menus and having different text, such that when the second signal is received a second operation is performed, the second operation being substantially the same for each one of the plurality of second soft keys.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A illustrates a simplified exemplary prior art menu showing three generic selections that may be selected by a user.

FIG. 1B illustrates another simplified exemplary prior art menu showing three generic settings that may be selected by a user.

FIG. 2 illustrates a block diagram of an embodiment of the present invention implemented in a digital camera.

FIG. 3A is a simplified exemplary menu showing three generic selections that may be selected by a user using an embodiment of the present invention.

FIG. 3B illustrates another simplified exemplary menu showing three generic settings that may be selected by a user using an embodiment of the present invention.

FIGS. 4A and 4B are illustrations of simplified exemplary menus of an embodiment of the present invention configured to operate with three soft keys.

FIG. 5 is a flow chart illustrating a process for providing an easily understood menu control system by an embodiment of the menu navigation system.

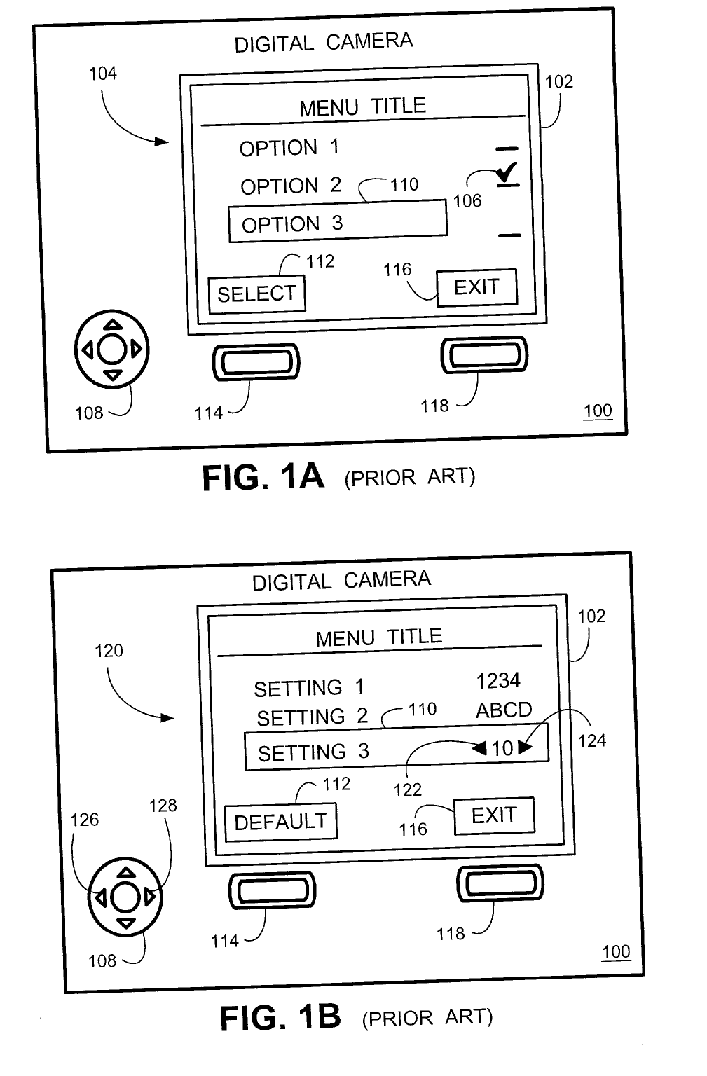

### DETAILED DESCRIPTION

One embodiment of menu navigation system 200 provides a system and method for operating menus employed by an electronic device, such as, but not limited to, a digital camera. The menus are configured such that a user may select, enable and/or adjust various parameters, such as, but not limited to, options and settings, that control operation of the electronic device. The system and method for operating a digital camera menu provides soft keys having a consistent functionality for controllers. In addition, the menu navigation system and method provides an easily understood arrangement for soft keys and their associated controllers when performing the same function for various operating modes. Thus, the system and method for operating a menu results in consistent and unambiguous operation.

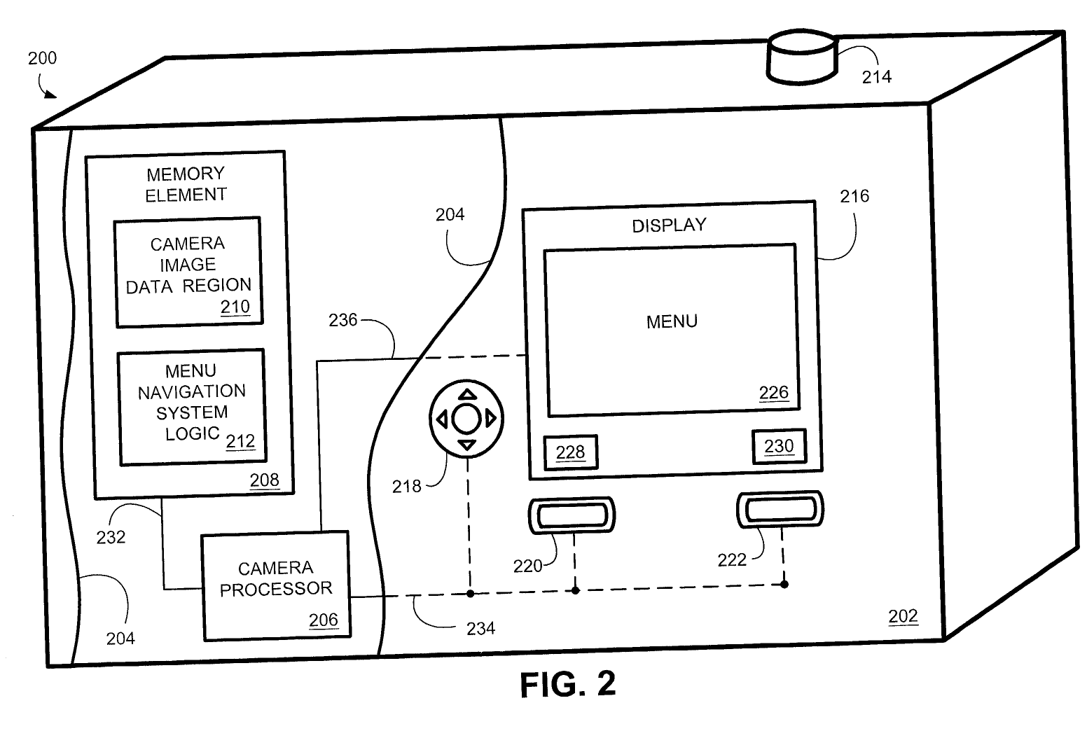

FIG. 2 is a block diagram of one embodiment of the present invention implemented in digital camera 202. For convenience, external and internal components of digital camera 202 are separated by cut-away lines 204. The internal components include at least camera processor 206 and memory element 208. Memory element 208 further includes at least the camera image data region 210 and the menu navigation system logic 212.

External components include an image capture actuation button 214, a display 216, and a plurality of controllers. The exemplary digital camera 100 is illustrated as having a four-way controller 218 and controllers 220 and 222. Display 216 is used for previewing images prior to capturing, for viewing captured images, or for viewing menus. For convenience of illustration, the display 216 is illustrated as residing on the back side of the digital camera 202.

When the operator (not shown) has focused the image to be captured and is satisfied with the nature of the image that will be captured by the digital camera 202, the operator actuates the image capture actuation button 214 (also referred to as a shutter button or a shutter release button) to cause the digital camera 202 to record a digital image, thus “photographing” the image. The operator of the digital camera may visually preview the image before capturing the image on display 216 and/or view the image directly through viewing lens (not shown). Data corresponding to the captured image is stored in the camera image data region 210. Other embodiments store data corresponding to the captured image on other suitable memory mediums. Detailed operation of capturing images with digital camera 202 is not described in detail herein.

Digital camera 202 also includes additional components not shown in FIG. 2. Such components are not discussed herein as such components are not necessarily related to the operation and functionality of the menu navigation system logic 212. Furthermore, for convenience of illustration, digital camera 202 is illustrated from a perspective that shows only the back, top and one side view of the digital camera 202. Digital camera 202 has additional components, not shown, residing on the illustrated sides and the hidden sides of the digital camera 202. Such components are not illustrated or discussed herein as such components are not necessarily related to the operation of the digital camera 202 with respect to the embodiments of the menu navigation system logic 212.

During the operation of digital camera 202, menu 226 may displayed on display 216 when it is appropriate for the user to select, change and/or modify camera operation attributes. Associated with menu 226 are soft keys 228 and 230. Soft key 228 includes descriptive text corresponding to the operating functionality of controller 220. Accordingly, the descriptive text of soft key 228 generally describes the operation that will occur when controller 220 is actuated. Thus, actuation of controller 220 communicates a signal indicating that the operation associated with soft key 228 is to be performed. Preferably, the descriptive text is a single word, although phrases are used in alternative embodiments. Similarly, soft key 230 includes descriptive text corresponding to the operating functionality of controller 222.

When menu 226 is displayed, camera processor retrieves menu navigation system logic 212 from memory element 208, via connection 232, and executes logic associated with menu navigation system logic 212. When four-way controller 218 and/or controllers 220 and 222 are actuated by the user, control signals are received, via connection 234, by camera processor 206. Camera processor 206 provides a suitable signal to display 216, via connection 236, such that the appropriate attributes of menu 226 are displayed (or such that menu 226 is no longer displayed, depending upon the received control signals).

For convenience, connections 236 and 234 are illustrated as dashed lines on the illustrated outside portion of digital camera 202 to denote that the connections are internal components. Furthermore, for convenience, connections 234 and 236 are illustrated as a single connection. Other embodiments may employ individual connections from each controller to camera processor 206, may employ connections from the controllers to a common communication bus accessible to camera processor 206, or may require a plurality of connections if multiple functionality is provided from a single controller. Similarly, other embodiments may employ a plurality of connections, and or a common bus, between camera processor 206 and display 216.

The above-described four-way controller 218, and/or controllers 220 and 222, may be implemented using any suitable actuating device configured to at least allow a user operate a displayed menu 226 according to the present invention. Examples of such controllers include, but are not limited to, a push-button, a toggle-switch, a multi-position sensing device configured to sense a plurality of switch positions, a touch sensitive switch or a light sensitive device. Furthermore, the functionality of the controllers may be alternatively implemented on a multi-function touch sensitive device, such as a touch pad, or on a “mouse” device, such that the soft keys 228 and 230 of the present invention correspond to controllers associated with the touch sensitive device and/or mouse.

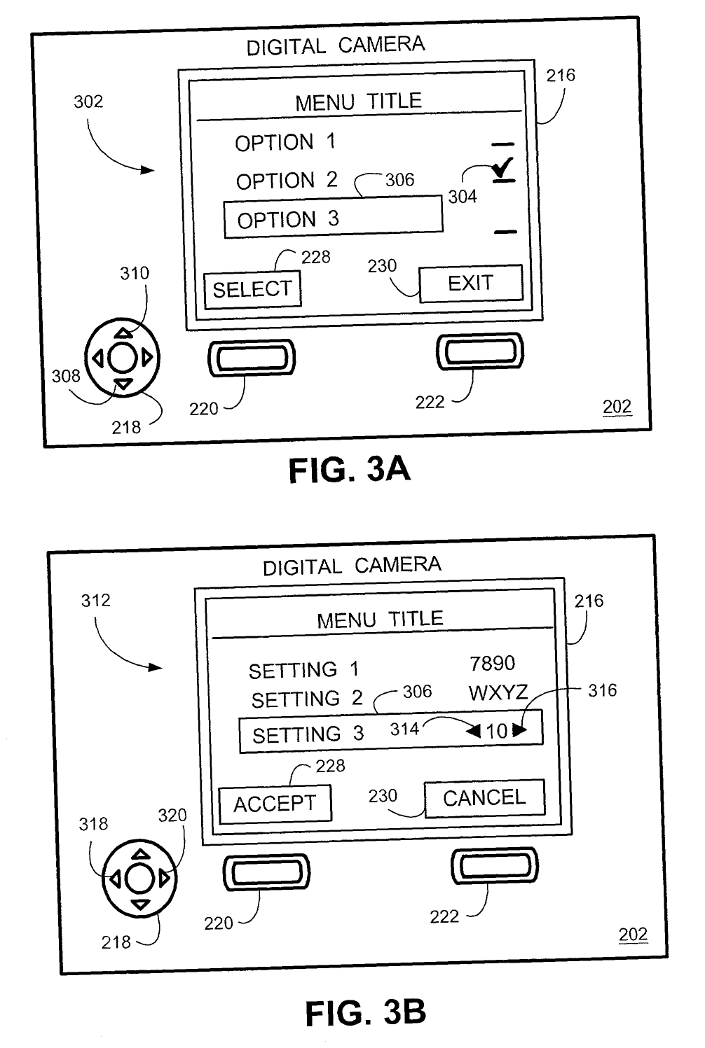

FIG. 3A is a simplified exemplary menu 302 showing three generic selectable features that may be selected by a user using an embodiment of the present invention. Menu 302 is displayed on display 216 (FIG. 2) of camera 202. The status of the selectable features, here labeled as options for convenience, are indicated by the presence of a status icon, such as checkmark 304. Thus, the presence of checkmark 304 indicates that Option 2 is activated, and the absence of a similar checkmark indicates that Option 1 is not activated.

On the exemplary menu 302, an interface is employed to instruct the user as to the functionality of various controllers. A soft button instruction 228, referred to herein as a soft key for convenience, displays the descriptive text “SELECT” to indicate that if the user actuates controller 220, residing just below the soft key 228, that Option 3 will be selected (thereby changing the menu 302 to display a checkmark adjacent to Option 3). For example, the menu 302 is illustrated as having Option 3 selected as indicated by highlight bar 306. Accordingly, the user understands that Option 3 may be changed from an unselected status (since no checkmark is currently displayed for Option 3) to a selected status by first highlighting Option 3 (assuming that Option 3 is not already highlighted), and actuating soft key 228.

When the exemplary menu 302 is displayed, the user selects an option by actuating a suitable controller, such as the four-way controller 218 in one embodiment. Downward-pointing arrow 308 on four-way controller 218, in one embodiment, when actuated, causes the highlight bar 306 to move downward to the next option displayed on menu 302. Similarly, upward-pointing arrow 310 on four-way controller 218, in one embodiment, when actuated, causes the highlight bar 306 to move upward to the next option displayed on menu 302. Accordingly, the user understands that actuating the top side of four-way controller 218 will move highlight bar 306 upward to the next option and that actuating the bottom side of four-way controller 218 will move highlight bar 306 downward to the next option. Thus, the operation of the four-way controller 218 in conjunction with menu 302 is easily understood and remembered by the user.

In accordance with the present invention, actuation of controller 220, or an equivalent controller implemented in an alternative embodiment, causes the current highlighted option to be selected (or deselected if that highlighted Option is currently selected) and the menu 302 to be exited from. Accordingly, when the user actuates the controller 220 corresponding to soft key 228 (displaying the descriptive text “SELECT”), the user understands that the desired action will be effected (selection of Option 3) and the menu 302 will be exited. Thus, actuation of controller 220 communicates a signal indicating that the operation associated with soft key 228 is to be performed. As will be described in below, other menus of the digital camera 202 will cause a similar acceptance of the menu activity and a subsequent exiting from that menu.

When the user determines that altering the options of menu 302 is not desirable, the user desires to exit the menu without saving any changes to the options, and return to a predefined operating mode. Here, the soft key 230 displaying the descriptive text “EXIT” indicates to the user that actuation of controller 222 exits from menu 302, and that no changes to the options listed in menu 302 will be made. Thus, actuation of controller 222 communicates a signal indicating that the operation associated with soft key 230 is to be performed.

Digital camera 202 will be operated with a plurality of different types of menus that are displayed on display 216. FIG. 3B is another simplified exemplary menu 312 showing three generic selectable features that may be selected by a user using an embodiment of the present invention. Menu 312 enables the user to change the selectable feature, referred to as a setting for convenience, of the digital camera 202. Three generic settings are illustrated for convenience. Setting 1 has a setting of 7890, Setting 2 has a setting of WXYZ, and Setting 3 has a setting of 10. For illustrative purposes, assume that the user desires to reduce the value of Setting 3. Using four-way controller 218, Setting 3 is highlighted, as indicated by highlight bar 306.

Once highlighted, diamonds 314 and 316 indicate to the user how to alter the value of Setting 3. Furthermore, the left-pointing diamond 314 corresponds to the left-pointing arrow 318 on four-way controller 218 such that the user understands that actuating the left side of four-way controller 218 will reduce the value of Setting 3. Similarly, the right-pointing diamond 316 corresponds to the right-pointing arrow 320 on four-way controller 218 such that the user understands that actuating the right side of four-way controller 218 will increase the value of Setting 3.

On menu 312, soft key 228 is labeled with the descriptive text “ACCEPT” to indicate that actuation of controller 220 will cause the current (and presumably altered) highlighted setting to be accepted as the current setting. Also, if other settings were previously changed on that menu, the previously changed settings are accepted. Furthermore, actuation of controller 220 will also cause exiting from menu 312 to a predefined state. For example, if the value of Setting 3 is 10, actuation of the left side of four-way controller 218 causes the value of Setting 3 to be reduced by a predefined amount. Then, actuation of controller 220 (corresponding to the soft key 228 having the “ACCEPT” descriptive text) causes the revised setting to be saved as the current setting and causes the exiting from menu 312.

Furthermore, on menu 312, soft key 230 is labeled with the descriptive text “CANCEL” to indicate that actuation of controller 222 will cause an exiting from menu 312 without the saving of the changed value(s). Thus, if the user makes any undesirable setting changes, actuation of the “CANCEL” soft key 230 provides a convenient and reliable way to discard the revised setting values and to exit from menu 312.

Table 2 summarizes the functionality of the soft keys 220 and 222 for the simplified illustrative example menus 302 and 312 described above.

TABLE 2
Exemplary Soft Key Operations

| Menu | Soft Key Text | Result of Actuating Corresponding Controller |
|---|---|---|
| 302 | SELECT | Change status of current highlighted option and |
| | | exit menu |
| 302 | EXIT | Cancel any option changes and exit menu |
| 312 | ACCEPT | Change setting of current highlighted setting and |
| | | exit menu |
| 312 | CANCEL | Cancel any option changes and exit menu |

Table 2 and the above-described operation of the simplified menus 302 and 312 illustrate in an exemplary manner an embodiment of the present invention, as determined by logic of the menu navigation system 200 (FIG. 2), that controls operation of soft keys 228 and 230, and their corresponding controllers 220 and 222. Even though the descriptive text describing the functionality of the soft keys 228 and 230 may differ depending upon the current menu displayed, the general operation of a soft key 228 and 230 does not significantly change with different menus. That is, the user understands that actuation controller 220 and/or controller 222 will have substantially the same effect, regardless of the current operating menu.

Summarizing the above-described exemplary embodiment, the user conveniently remembers that actuation of controller 220, or an equivalent controller implemented in an alternative embodiment, causes the digital camera 202 to accept the current menu activity and to exit the current menu. Similarly, the user conveniently remembers that actuation of controller 222, or an equivalent controller implemented in an alternative embodiment, causes the digital camera 202 to exit the current menu without saving any changes. Such a feature is desirable in a digital camera 202 designed and configured to operate in a simplified manner. That is, the less complex a menu operation is to execute and/or remember, the easier the digital camera 202 is to use. Such embodiments of digital camera 202 are desirable to some users.

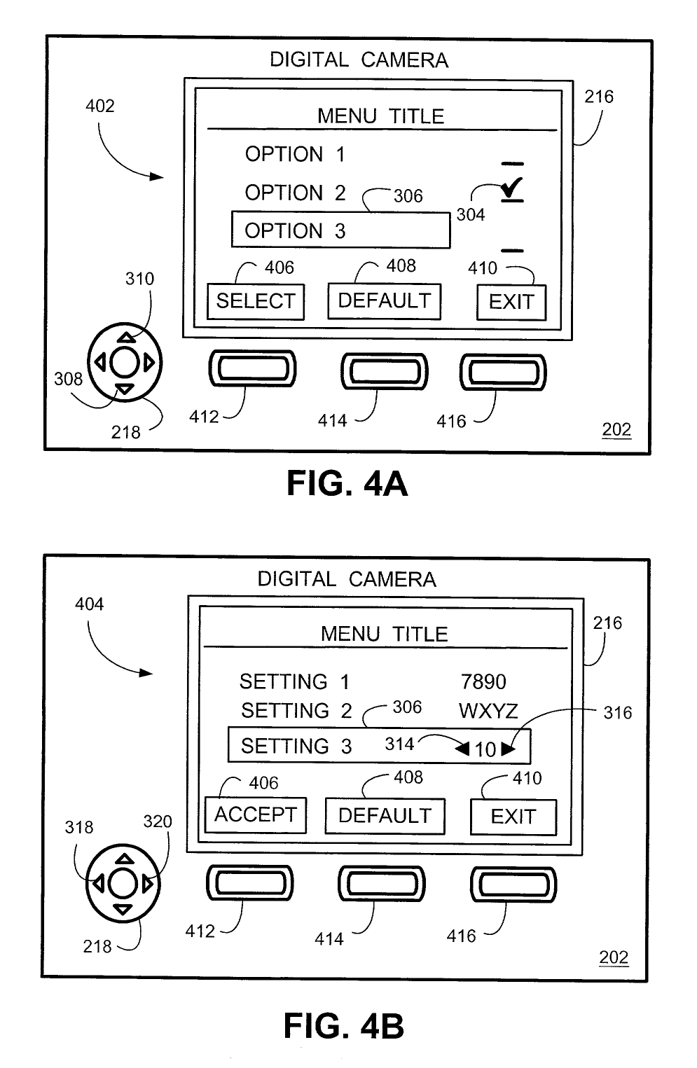

For convenience, menu 302 and menu 312 were illustrated and described as having two soft keys 228 and 230, and their respective controllers 220 and 222. FIGS. 4A and 4B are simplified exemplary menus 402 and 404 of an embodiment of the present invention configured to operate with three soft keys 406, 408 and 410. Similar to previously described embodiments, each of the soft keys 406, 408 and 410 are associated with a respective controller 412, 414 and 416.

Menu 402 is similar to the above-described menu 302 (FIG. 3A) in that the soft key 406 having the associated descriptive text “SELECT” corresponds to soft key 228 as illustrated in FIG. 3A. Soft key 410 having the associated descriptive text “EXIT” is likewise similar to soft key 230 as illustrated in FIG. 3A.

However, a third soft key 408 having the descriptive text “DEFAULT” is provided, along with a corresponding controller 414. With this embodiment, the selected option will be set to a default value when controller 414 is actuated.

Menu 404 is similar to the above-described menu 312 (FIG. 3B) in that the soft key 406 having the associated descriptive text “ACCEPT” corresponds to soft key 228 as illustrated in FIG. 3B. Soft key 410 having the associated descriptive text “EXIT” is likewise similar to soft key 230 for menu 302 have as illustrated in FIG. 3A.

Additionally, a third soft key 408 having the descriptive text “DEFAULT” is provided, along with a corresponding controller 414. With this embodiment, the selected setting will be set to a default value and/or setting when controller 414 is actuated. Another embodiment changes all setting on the menu to default values.

Comparing the operation of soft keys 406, 408 and 410 in FIGS. 4A and 4B illustrate that the soft keys have similar effect. Thus, the soft keys 406, 408 and 410 are easily understood and remembered by the user. In the simplified illustrative example of FIGS. 4A and 4B, soft key 406 is configured to save the current menu setting as exit from the menu. In menu 402, the descriptive text “SELECT” is associated with soft key 406. In menu 404, the descriptive text “ACCEPT” is associated with soft key 406. Even though the descriptive text for soft key 406 is deferent on menus 402 and 404, their operative effect is substantially similar. Thus, the user really need only to remember that actuation of controller 412 causes a saving of the current menu values and/or settings, and that the menu will be exited.

Soft keys 414 and 416, having the associated descriptive text “DEFAULT” and “EXIT” respectively, have the same functionality in both menus 402 and 404. Thus, using the same descriptive text for the same soft key among a plurality of menus further simplifies the operation of the menu navigation system 200.

For convenience, the menus 302, 312, 402 and 404 were illustrated and described to demonstrate an embodiment of the menu navigation system 200 according to the present invention. Alternative embodiments of the menu navigation system 200 are equally applicable to other types and/or forms of menus that employ soft keys and controllers as described herein. Furthermore, other types of menus, and their associated controllers, that do not practice the present invention may be used in conjunction with the menu navigation system 200. That is, the menu navigation system 200 is compatible, and may be used concurrently, with other menu navigation and/or operating systems.

Alternative embodiments of the navigation menu system 200 employ only one soft key according to the present invention. Other embodiments employ four or more soft keys.

Yet another embodiment may employ different numbers of soft keys among the plurality of menus, depending upon the functionality of a particular menu involved. For example, but not limited to, a menu 302 (FIG. 3A) and a menu 402 (FIG. 4A) may be employed in an embodiment. Here, soft keys 228 and 406 have the same functionality. Similarly, soft keys 230 and 410 have similar functionality. When the user is operating within menu 302, the third soft key is not used. When the user is operating within menu 402, the third soft key 408 is used. However, the user understands that the functionality of soft keys 228 and 230 on menu 302 are substantially similar to the soft keys 406 and 410, respectively, on menu 402.

For convenience, menu 302 was illustrated as having three options. Similarly, menu 302 was illustrated as having three settings. The present invention is equally applicable to menus having one, two or more than three options or settings.

Furthermore, for convenience, menu 302 was illustrated and described as having three generic options; Option 1, Option 2 and Option 3. No functionality was associated with an option. It is understood that any suitable functionality may be assigned to an option, and any suitable descriptive text for an option may be displayed on the menu 302, without departing substantially from the operation and functionality of the menu navigation system 200. Similarly, for convenience, menu 312 was illustrated and described as having three generic settings; Setting 1, Setting 2 and Setting 3. No functionality was associated with a setting. It is understood that any suitable functionality may be assigned to a setting, and any suitable descriptive text for a setting may be displayed on the menu 312, without departing substantially from the operation and functionality of the menu navigation system 200.

Accordingly, a general embodiment of the present invention provides for control of a plurality of menus, each menu having at least two soft keys. Soft keys are located in a substantially similar position on their respective menu. For example, soft keys corresponding to a common controller may use different descriptive text. Thus, the size of the soft keys may be different. However, the soft keys are located in a substantially similar position on their respective menu, namely, in close proximity to the controller.

Controller 218 was described as a four-way controller having a plurality of operating functions depending upon the manner in which the four-way controller 218 is actuated. Four-way controller 218 was used for convenience and to facilitate the description of the menu navigation system 200. Thus, controller 218 is not a necessary element in the menu navigation system 200. Furthermore, other controllers may be employed with or in lieu of four-way controller 218. Thus, other controllers may be used equally well with the present invention to facilitate selection of menu items residing on the menus and/or for changing selected menu items. Accordingly, such alternative controllers and menu operating systems are compatible with, and may be used concurrently with, the menu navigation system 200 according to the present invention.

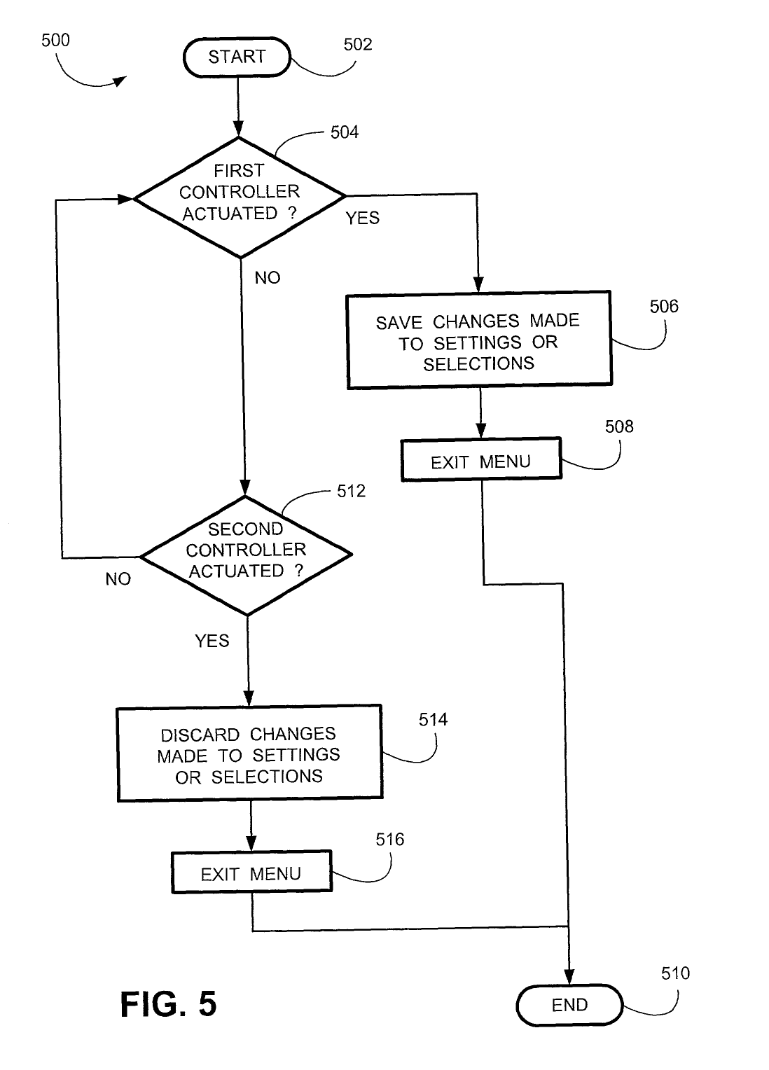

FIG. 5 is a flow chart 500 illustrating a process for providing an easily understood menu control system by an embodiment of the menu navigation system 200. The flow chart 500 represents an embodiment of software for implementing the menu navigation system logic 212 (FIG. 2). In this regard, each block may represent a module, segment, or portion of code, which comprises one or more executable instructions for implementing the specified logical function(s). It should also be noted that in some alternative implementations, the functions noted in the blocks may occur out of the order noted in FIG. 5 or may include additional functions without departing significantly from the functionality of the menu navigation system 200. For example, two blocks shown in succession in FIG. 5 may in fact be executed substantially concurrently, the blocks may sometimes be executed in the reverse order, or some of the blocks may not be executed in all instances, depending upon the functionality involved, as will be further clarified below. All such modifications and variations are intended to be included herein within the scope of this disclosure for the menu navigation system 200 and to be protected by the accompanying claims.

The process starts at block 502. At block 504, a determination is made whether the first controller has been actuated. If the first controller has been actuated (the YES condition), the process proceeds to block 506 such that the changes made through the menu to settings, options or other menu selectable features are saved. The process then proceeds to block 508 where the current menu is exited. The process ends at block 510.

If the first controller has not been actuated at block 504 (the NO condition), the process proceeds to block 512 where a determination is made whether the second controller has been actuated. If not (the NO condition), the process returns back to block 504 to determine if the first controller has been actuated. Thus, the loop of blocks 504 and 512 is repeated until either the first controller or the second controller is actuated.

If at block 512 the second controller has been actuated (the YES condition), the process proceeds to block 514 such that any changes that have been made to settings, selections or other menu selectable features are discarded. That is, any changes made in the current menu are not saved. The process then proceeds to block 516 to exit the current menu. The process then proceeds to block 510 and ends.

The menu navigation system logic 212 of the invention can be implemented in software (e.g., firmware), hardware, or a combination thereof. In the currently contemplated best mode, the menu navigation system logic 212 (FIG. 2) is implemented in software, as an executable program, and is executed by the camera processor 206. The camera processor 206 is a hardware device for executing software, particularly that stored in memory element 208. The camera processor 206 can be any custom made or commercially available camera processor.

The memory element 208 can include any one or combination of volatile memory elements (e.g., random access memory (RAM, such as DRAM, SRAM, SDRAM, etc.) and nonvolatile memory elements (e.g., ROM, hard drive, tape, CDROM, etc.). Moreover, the memory element 208 may incorporate electronic, magnetic, optical, and/or other types of storage media. Note that the memory element 208 can have a distributed architecture, where various components are situated remote from one another, but can be accessed by the camera processor 206.

When the menu navigation system logic 212 is implemented in software, as is shown in FIG. 2, it should be noted that the menu navigation system logic 212 can be stored on any computer-readable medium for use by or in connection with any computer related system or method. In the context of this document, a computer-readable medium is an electronic, magnetic, optical, or other physical device or means that can contain or store a computer program for use by or in connection with a computer related system or method. The menu navigation system logic 212 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In an alternative embodiment, where the menu navigation system logic 212 is implemented in hardware, the menu navigation system logic 212 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For convenience, the present invention, the navigation menu system 200, was described as implemented in a digital camera 202 having a display 216 and operated using a plurality of menus. Other embodiments are equally applicable in other types of image captures devices, such as, but not limited to, film cameras, facsimile (FAX) machines, copy machines, kiosk devices, personal computers (desktops, lap tops, notebooks, etc.), pagers, personal digital assistants (PDAs) and other electronic devices having a display and employing soft keys and a plurality of menus according to the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A method for controlling operation of an electronic device using menus, the method comprising the steps of:
receiving a first signal from a first controller, the first controller associated with a plurality of first soft keys, each one of the first soft keys on a corresponding one of a plurality of menus and having different text, such that when the first signal is received a first operation is performed, the first operation being substantially the same for each one of the plurality of first soft keys; and
receiving a second signal from a second controller, the second controller associated with a plurality of second soft keys, each one of the second soft keys on the corresponding one of the plurality of menus and having different text, such that when the second signal is received a second operation is performed, the second operation being substantially the same for each one of the plurality of second soft keys.

2. The method of claim 1, further comprising the step of receiving a third signal from a third controller, the third controller associated with a plurality of third soft keys, each one of the third soft keys on the corresponding one of the plurality of menus and having different text, such that when the third signal is received a third operation is performed, the third operation being substantially the same for each one of the plurality of third soft keys.

3. A system that controls operation of an electronic device using menus displayed on a display:
a plurality of menus, each one of the plurality of menus having a first location and a second location, the first location on each of the menus corresponding to a substantially similar position on each one of the menus, and the second location on each of the menus corresponding to another substantially similar position on each one of the menus;
a first soft key residing on a first one of the plurality menus, the first soft key being positioned in the first location on the first menu and having a first descriptive text, the first descriptive text corresponding to a first operation effected when a first controller is actuated;
a second soft key residing on the first menu, the second soft key being positioned in the second location on the first menu and having a second descriptive text, the second descriptive text corresponding to a second operation effected when a second controller is actuated;
a third soft key residing on a second one of the plurality menus, the third soft key being positioned in the first location on the second menu and having a third descriptive text, the third descriptive text corresponding to the first operation effected when the first controller is actuated;
a fourth soft key residing on the second menu, the fourth soft key being positioned in the second location on the second menu and having a fourth descriptive text, the fourth descriptive text corresponding to the second operation effected when the second controller is actuated.

4. The system of claim 3, further comprising an image capture device having the display, and such that the plurality of menus control selectable operating features of the image capture device.

5. The system of claim 4, wherein the image capture device is a digital camera.

6. The system of claim 4, wherein the image capture device is a film camera.

7. The system of claim 3, wherein the first controller is located substantially adjacent to the first soft key and the second soft key, and wherein the second controller is located substantially adjacent to the second soft key and the fourth soft key.

8. The system of claim 3, wherein the first descriptive text is different from the third descriptive text.

9. The system of claim 3, wherein the second descriptive text is different from the fourth descriptive text.

10. The system of claim 3, wherein the first operation saves a change made to a selected menu feature and exits from a current menu displayed on the display, and wherein the second operation rejects the change made to the selected menu feature and exits from the current menu.

11. The system of claim 3, further comprising:
a fifth soft key residing on the first menu, the fifth soft key being positioned in a third location on the first menu and having a fifth descriptive text, the fifth descriptive text corresponding to a third operation effected when a third controller is actuated; and
a sixth soft key residing on the second menu, the sixth soft key being positioned in the third location on the second menu and having a sixth descriptive text, the sixth descriptive text corresponding to the third operation effected when a third controller is actuated, wherein the third operation saves a predefined default to a selected menu feature and exits from a current menu displayed on the display.

12. A method for controlling operation of an electronic device using menus, the method comprising the steps of:
displaying a selected first one of a plurality of menus, the selected first menu having at least a first soft key and a second soft key, the first soft key configured to indicate a first menu operation associated with a corresponding first controller, and the second soft key configured to indicate a second menu operation associated with a corresponding second controller;
displaying a selected second one of the plurality of menus, the selected second menu having at least a third soft key and a fourth soft key, the third soft key configured to indicate a third menu operation associated with the corresponding first controller, and the fourth soft key configured to indicate a fourth menu operation associated with a corresponding second controller;
receiving a first signal from the first controller such that the first menu operation is performed when the first menu is displayed, and such that the third menu operation is performed when the second menu is displayed, the first and the third menu operations being substantially equivalent; and
receiving a second signal from the second controller such that the second menu operation is performed when the first menu is displayed, and such that the fourth menu operation is performed when the second menu is displayed, the second and the fourth menu operations being substantially equivalent.

13. The method of claim 12, wherein the step of displaying the first menu further comprises the steps of:
displaying a first text associated with the first soft key, wherein the first text generally describes the first menu operation; and
displaying a second text associated with the second soft key, wherein the second text generally describes the second menu operation, and wherein the step of displaying the second menu further comprises the steps of:
displaying a third text associated with the third soft key, wherein the third text generally describes the third menu operation, and wherein the third text is different from the first text; and
displaying a fourth text associated with the fourth soft key, wherein the fourth text generally describes the fourth menu operation, and wherein the fourth text is different from the second text.

14. The method of claim 12, further comprising the steps of:
displaying the first menu having a fifth soft key, the fifth soft key configured to indicate a fifth menu operation associated with a corresponding third controller;
displaying the second menu having a sixth soft key, the sixth soft key configured to indicate a sixth menu operation associated with the corresponding third controller;
receiving a third signal from the third controller such that the fifth menu operation is performed when the first menu is displayed, and such that the sixth menu operation is performed when the second menu is displayed, the fifth and the sixth menu operations being substantially equivalent.

15. The method of claim 14, wherein the step of displaying the first menu further comprises the step of displaying a fifth text associated with the fifth soft key, wherein the fifth text generally describes the fifth menu operation, and wherein the step of displaying the second menu further comprises the step of displaying a sixth text associated with the sixth soft key, wherein the sixth text generally describes the sixth menu operation, and wherein the fifth text is different from the sixth text.

16. A computer-readable medium having a program for controlling operation of an electronic device using menus, the program comprising logic configured to perform the steps of:
displaying a first soft key on a first menu, the first soft key having a first text corresponding to a first menu operation;
displaying a second soft key on the first menu, the second soft key having a second text corresponding to a second menu operation;
displaying a third soft key on a second menu, the third soft key having a third text corresponding to a third menu operation;
displaying a fourth soft key on the second menu, the fourth soft key having a fourth text corresponding to a fourth menu operation;
such that the first text and the third text are different and the first menu operation and the third menu operation are substantially similar, and such that the second text and the fourth text are different and the second menu operation and the fourth menu operation are substantially similar.

17. The medium of claim 16, wherein the program further comprises logic configured to perform the steps of:
displaying a fifth soft key on the first menu, the fifth soft key having a fifth text corresponding to a fifth menu operation;
displaying a sixth soft key on the second menu, the sixth soft key having a sixth text corresponding to a sixth menu operation;
such that the fifth text and the sixth text are different and the fifth menu operation and the sixth menu operation are substantially similar.

18. A system that controls operation of an electronic device using menus, comprising:
means for generating a first signal associated with a plurality of first soft keys, each one of the first soft keys on a corresponding one of a plurality of menus and having different text;
means for receiving the first signal such that when the first signal is received a first operation is performed, the first operation being substantially the same for each one of the plurality of first soft keys;
means for generating a second signal associated with a plurality of second soft keys, each one of the first soft keys on a corresponding one of the plurality of menus and having different text; and
means for receiving the second signal such that when the second signal is received a second operation is performed, the second operation being substantially the same for each one of the plurality of second soft keys.

19. The method of claim 18, further comprising:
means for generating a third signal associated with a plurality of third soft keys, each one of the third soft keys on a corresponding one of the plurality of menus and having different text; and
means for receiving the third signal such that when the third signal is received a third operation is performed, the third operation being substantially the same for each one of the plurality of third soft keys.
